(19) United States
(12) Patent Application Publication
(10) Pub. No.: US 2025/0350912 A1
(43) Pub. Date: Nov. 13, 2025

(54) KNOWLEDGE BENEFITS THROUGH PRE-IDENTIFIED SET OF NETWORK LINKS

(71) Applicant: TOYOTA MOTOR ENGINEERING & MANUFACTURING NORTH AMERICA, INC., Plano, TX (US)

(72) Inventors: Seyhan Ucar, Mountain View, CA (US); Onur Altintas, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/658,711

(22) Filed: May 8, 2024

(51) Int. Cl. H04W 4/44; G06N 5/02; H04W 4/38

(52) U.S. Cl. CPC H04W 4/44; G06N 5/02; H04W 4/38

(57) ABSTRACT

Systems and methods are provided for facilitating knowledge transfer from a vehicle to an end entity. The system can determine a criterion associated with the knowledge transfer and prepare a set of network links based on the determined criterion. The system can determine whether the vehicle created knowledge to be transmitted to the end entity and deploy the set of network links based on a determination that the vehicle created knowledge to be transmitted to the end entity. Using the network links, the knowledge can be transmitted to the end entity.

### TECHNICAL FIELD

The present disclosure relates generally to data transmission from vehicles to remote servers, and in particular, some implementations may relate to the development of knowledge from raw data and the transmission of that knowledge.

### DESCRIPTION OF RELATED ART

Vehicles can collect or generate data using sensors or vehicle systems. Raw data can be formatted in various ways, including by time, speed, position, etc. This raw data by itself may not provide any conclusions or insights into a particular situation or environment. However, vehicles can process this data to generate information answering basic questions about the situation or environment. This information can comprise descriptions on the key components, parties, locations, or features of a situation or environment. Patterns in information can be analyzed to generate knowledge about a situation. Here, knowledge can refer to any facts extracted by analyzing the patterns in information and raw sensor data. Knowledge can be used by vehicles to make determinations as to how to respond to a situation. Knowledge can indicate which vehicle systems to use, which sensors to apply, what trajectory to take, or any other vehicle action in response to a situation or environment. Knowledge can be annotated with the relevant information or raw data that led to its creation. This knowledge can be transmitted to remote servers or to other vehicles for any use, including analyzing other patterns of information or responding to similar situations or environments.

### BRIEF SUMMARY OF THE DISCLOSURE

According to various embodiments of the disclosed technology, a method can comprise determining a criterion associated with knowledge transfer between a vehicle and an end entity; preparing a set of network links between the vehicle and the end entity based on the determined criterion; determining whether the vehicle created knowledge to be transmitted to the end entity, wherein the knowledge comprises patterns of information generated by processing sensor data from the vehicle; deploying the set of network links based on a determination that the vehicle created knowledge to be transmitted to the end entity; and transmitting the knowledge to the end entity in accordance with the set of network links.

In some embodiments, the set of network links connect a plurality of remote servers between the vehicle and the end entity.

In some embodiments, the method further comprises analyzing the transmission of the knowledge based on the criterion; and updating the set of network links.

In some embodiments, the criterion is associated with knowledge transfer between a plurality of vehicles and the end entity.

In some embodiments, the criterion comprises at least one of maximum data diversity or maximum target users.

In some embodiments, determining the criterion comprises performing a time series analysis on the vehicle and the end entity to determine the criterion.

In some embodiments, the method further comprises storing the set of network links to be deployed in future knowledge transmission.

In some embodiments, the set of network links can be deployed in future knowledge transmission associated with the criterion.

According to various embodiments of the disclosed technology, a system can comprise a processor and a memory coupled to the processor to store instructions, which when executed by the processor, can cause the processor to determine a plurality of criteria associated with knowledge transfer between a vehicle, an end entity, and a plurality of remote servers linking the vehicle to the end entity; prepare a set of network links between the vehicle and the end entity traversing the plurality of remote servers based on the plurality of criteria; determine whether the vehicle created knowledge to be transmitted to the end entity, wherein the knowledge comprises patterns of information generated by processing sensor data from the vehicle; deploy the set of network links based on a determination that the vehicle created knowledge to be transmitted to the end entity; and transmit the knowledge between the plurality of remote servers to the end entity in accordance with the set of network links.

In some embodiments, the instructions further cause the processor to analyze the transmission of the knowledge based on the criteria and update the set of network links.

In some embodiments, the criteria is associated with knowledge transfer between a plurality of vehicles and the end entity.

In some embodiments, the criteria comprise at least one of maximum data diversity or maximum target users.

In some embodiments, determining the criteria comprises performing a time series analysis on the vehicle, the plurality of remote servers, and the end entity to determine the criteria.

In some embodiments, the processor is further configured to store the set of network links to be deployed in future knowledge transmission.

In some embodiments, the set of network links can be deployed in future knowledge transmission associated with the criteria.

According to various embodiments of the disclosed technology, a non-transitory machine-readable medium can have instructions stored therein, which when executed by a processor, can cause the processor to determine a criterion associated with knowledge transfer between a vehicle and an end entity; prepare a set of network links between the vehicle and the end entity based on the determined criterion; determine whether the vehicle created knowledge to be transmitted to the end entity, wherein the knowledge comprises patterns of information generated by processing sensor data from the vehicle; deploy the set of network links based on a determination that the vehicle created knowledge to be transmitted to the end entity; transmit the knowledge to the entity in accordance with the set of network links; and store the set of network links to be deployed in future knowledge transmission.

In some embodiments, the instructions further cause the processor to analyze the transmission of the knowledge based on the criterion and update the set of network links.

In some embodiments, the criterion comprises at least one of maximum data diversity or maximum target users.

In some embodiments, determining the criterion comprises performing a time series analysis on the vehicle and the end entity to determine the criterion.

In some embodiments, the set of network links can be deployed in future knowledge transmission associated with the criterion.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example representation of knowledge creation in accordance with various embodiments described herein.

FIG. 2 illustrates an example environment where network links can be deployed in accordance with one embodiment.

FIG. 3 illustrates an example architecture for the creation and deployment of pre-identified network links in accordance with one embodiment of the systems and methods described herein.

FIG. 4 illustrates an example method in accordance with one embodiment of the systems and methods described herein.

FIG. 5 is an example computing component that may be used to implement various features of embodiments described in the present disclosure.

The figures are not exhaustive and do not limit the present disclosure to the precise form disclosed.

### DETAILED DESCRIPTION

Vehicles can network and share knowledge to reduce the cost and volume of communication. Raw data can be voluminous, resulting in longer or slower transmission times. Additionally, transmitting raw data to other vehicles or remote servers requires the vehicles or servers to process the data themselves to generate information, and then knowledge based on the patterns of information. The time it takes to process this raw data into information and then knowledge in combination with a delay in transmission can prevent other vehicles from acting in a timely manner to certain situations or environments. In contrast, knowledge generated from patterns of information is less voluminous. As a result, it is quicker to transmit knowledge and patterns in information as opposed to the raw data.

Furthermore, if only raw data is being transmitted, other vehicles receiving this data may process the data to generate different pieces of information. Since these different pieces of information may have different patterns, different knowledge may be created. There is no guarantee that another vehicle will generate the same knowledge as the vehicle transmitting the raw data. In some situations, it may be crucial that the vehicles actually have the same knowledge so that the vehicles' responses can be coordinated (e.g., in a collision or other hazardous situation). Instead of transmitting raw data, knowledge can be transmitted so that there is no difference between vehicles. Because the vehicles can have the same knowledge, they can coordinate responses to situations and environments accordingly.

While knowledge transmission can provide more benefits than transmitting raw data, knowledge transmission is not uniform. Once knowledge is created, it may need to be delivered to remote servers and other vehicles based on different criteria. For example, if a vehicle determines the presence and trajectory of a weaving driver, that trajectory may need to be transmitted to remote servers and other vehicles with minimal interruption. However, when the knowledge is timely created and needs to be transmitted, the network may be saturated and a minimum interruption link may not be found in time. As another example, a police car may need to broadly transmit knowledge to multiple vehicles, so it may need to locate remote servers with a maximum number of road commuters and the links between the remote servers with a minimum latency. If these remote servers and links need to be found in real-time as the knowledge is created, it may be too late once the required servers and links are determined.

Some systems try to alleviate these delays in various ways. In some systems, when the knowledge is created, it can be associated with a set of tags. These tags can comprise anything like location, priority, content, etc. By evaluating the tags, the systems may establish links and transmission routes a bit quicker. Similarly, in some systems, contextual features (e.g., location, road geometry, traffic flow) can be assigned to the knowledge during creation. The network can be queried and filtered according to the contextual features to deliver/retrieve the right knowledge with the right context. In other systems, metadata can be associated with the knowledge. The network can analyze the metadata to derive a knowledge creation path. The above systems can aim for minimal latency; however, the appropriate links are established after knowledge creation. Instead of transmitting the knowledge immediately, the above systems incur delays by analyzing tags, metadata, or contextual features to establish the appropriate transmission path. In addition, the same knowledge may be generated multiple times but may need to be delivered based on different criteria depending on the situation. For example, in one situation, the knowledge may need to be transmitted for maximum vehicle distribution, whereas in another environment, that same knowledge may need to be transmitted based on minimum interruption between links.

The embodiments of the systems and methods disclosed herein can eliminate the delay of analyzing metadata and tags by preparing a set of pre-identified network links before the knowledge is created. These pre-identified network links illustrate a transmission path to and between one or more remote servers based on the most frequently requested criteria by transmitting vehicles. Criteria can include any of the requirements described above, including minimum interruption, maximum vehicle distribution, and/or maximum data diversity. Once the links are established, they can be stored until knowledge is created and then immediately deployed. Since the links are created prior to knowledge creation, no time is needed to analyze the knowledge to derive the correct transmission path. This can reduce the transmission time. Furthermore, these links can be updated as the criteria from vehicles changes. Therefore, the same knowledge can be created and transmitted according to current criteria and thus may be transmitted in different ways depending on the situation or environment. In contrast, traditional systems may limit how particular knowledge is transmitted because it is associated with tags or metadata that determine the transmission path. Accordingly, the embodiments and systems described herein can tailor knowledge transmission to the current situation or environment regardless of whether the knowledge has been created or transmitted previously.

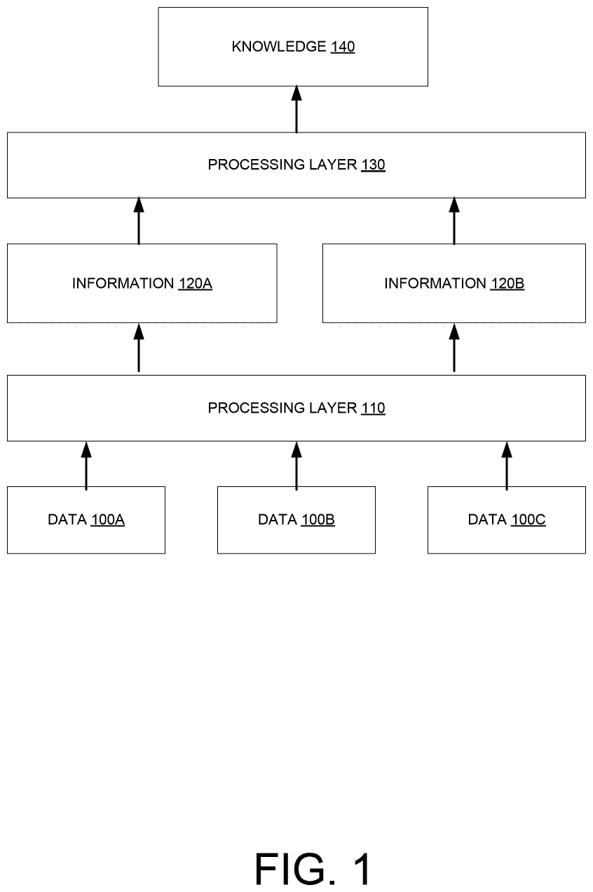

FIG. 1 illustrates an example creation of knowledge from raw data. Data 100A-C can comprise any raw data received or generated from vehicle sensors or vehicle systems. This data can also be received from other connected entities such as road side units, surveillance cameras, etc. Raw data can formatted in various ways, including based on time, speed, position, pressure, temperature, or any other measurement. As described above, raw data by itself may not be sufficient for a vehicle to determine a response to a situation or environment. Data 100A-C can be processed at layer 110 to generate information. Information can comprise descriptions on the key components, parties, locations, or features of a situation or environment. In effect, this information can describe who/what is responsible for a situation/environment, where the situation is located, when the situation is occurring, and why the situation is occurring. Processing the data into information can be accomplished using various methods. In some embodiments, binary classifications can be applied to the data. For example, deceleration data for a vehicle can be classified as “risky” or “not risky” based on threshold values for the deceleration. In other embodiments, the system can include pre-defined rules to classify the data. For example, a rule could comprise that a vehicle following another vehicle less than a particular distance is conducting risky behavior. In other embodiments, time series analyses or machine learning can be used to find patterns or contrasts between the data. For instance, a vehicle may receive sensor data comprising the vehicle's speed at a particular time. The vehicle may also receive sensor data comprising the vehicle's position at the same time. By attributing speed and position based on the same time, processor layer 110 may generate information stating that the vehicle was moving at a certain speed at a particular position. As another example, the vehicle may receive sensor data from a proximity sensor indicating a hazardous vehicle following at a very close distance. The vehicle may also receive speed data indicating the vehicle's speed. Based on the speed data, processing layer 110 can calculate an appropriate following distance (e.g., via the “three seconds rule”, etc.). Processing layer 110 can also determine that the hazardous vehicle is traveling behind the vehicle at a distance less than the appropriate following distance. Accordingly, processing layer 110 can generate information stating that the hazardous vehicle is not adhering to the appropriate following distance and is tailgating the vehicle.

Information 120A and 120B can be processed at processing layer 130 to determine knowledge 140. As described above, knowledge 140 can comprise any facts extracted based on patterns in the information. Processing layer 130 can search for patterns between information 120A and 120B to develop conclusions about a particular situation or environment. As described above for processing data into information, information can be processed into knowledge using similar methods including binary classification, system rules, time series analysis, machine learning, or any other method. For example, as described above, information may indicate that a hazardous vehicle is not adhering to the appropriate following distance and is thus tailgating. Additional information may indicate that one or more additional hazardous vehicles were tailgating near where the first hazardous vehicle was tailgating. Processing layer 130 can identify that multiple vehicles were tailgating in a particular area. As a result, knowledge 140 can indicate that a particular geographic area has a high risk for tailgating. A vehicle can use knowledge 140 to react in various ways. For example, to mitigate tailgating, the vehicle may reduce speed, change lanes, adjust trajectory, or may increase following distances. Knowledge 140 can be transmitted to other vehicles so that other vehicles can determine whether they are entering or will enter the high-risk area. The example of FIG. 1 can incorporate additional processing layers as necessary. For example, different pieces of knowledge can be processed to generate additional layers of knowledge. In other examples, information may comprise knowledge and may not require another level of processing.

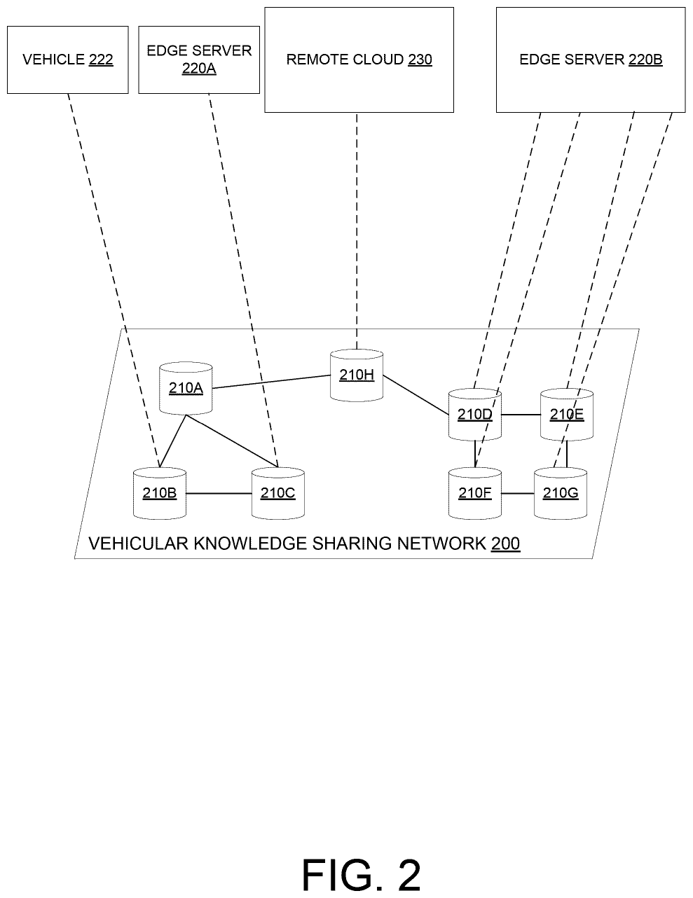

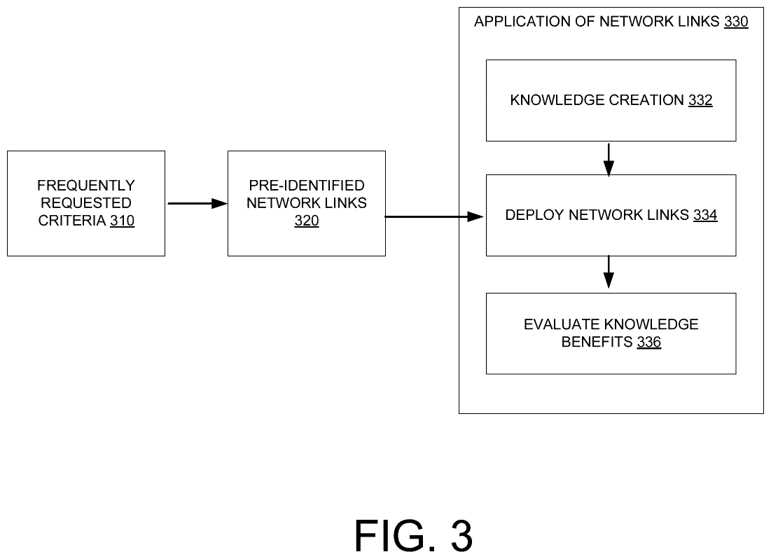

FIG. 2 illustrates an example environment where network links can be employed. Vehicular knowledge sharing network 200 can comprise remote servers 210A-210H. Remote servers 210A-210H may each receive knowledge from one or more vehicles, edge servers or infrastructure elements. In the example of FIG. 2, vehicle 222 can transmit knowledge to remote server 210B. Edge server 220A can transmit knowledge to remote server 210C. Edge server 220B can transmit knowledge to remote servers 210D-210G. Remote servers 210A-210H can be connected or linked in various ways depending on the structure of network 200. In FIG. 2, these links can be illustrated by the solid black lines between remote servers 210A-210H. A set of pre-identified network links (described further below in FIG. 3) can illustrate a path between these links. The path can lead to a particular end device, a remote cloud, or back to a remote server. As knowledge is transmitted, the goal may be to transmit the knowledge between remote servers to remote server 210H. Remote server 210H can be connected a remote cloud 230 which can store knowledge or provide a central repository of knowledge to be transmitted to any vehicles, edge servers, or infrastructure elements.

FIG. 3 illustrates an example system architecture for creating and deploying pre-identified network links. As described above, these links can connect remote servers in vehicular knowledge sharing network 200 to transmit knowledge to end devices (e.g., 220A, 220B, 222) or a remote cloud (e.g., remote cloud 230). At block 310, the system can receive requested criteria from end devices such as vehicles or edge servers. These criteria can indicate particular goals associated with knowledge transmission. Criteria can include, but is not limited to, maximum data/information/knowledge diversity, maximum target users, minimum interruption, and/or maximum quality. Maximum data/information/knowledge diversity can refer to paths with different data, information, and/or knowledge. Maximum target user can refer to paths leading to the highest number of end devices/users. Minimum interruption can refer to paths with the least interruption in transmission. Maximum quality can refer to any quality metrics for transmission, such as speed, latency, shortest path, etc.

In some embodiments, a remote server can perform a time series analysis on network 200 or other vehicular networks to derive the most frequently requested criteria. For example, the remote server can perform seasonal and trend decomposition time series analysis to understand seasonal and trend characteristics of the requested criteria. This knowledge can be stored for future use. In other embodiments, machine learning models can be trained with time series data to infer the most frequently requested criteria. In other embodiments, the criteria may be predetermined. In systems where time series analysis is employed, the system can periodically update the most frequently requested criteria. With updated criteria, new network links can be formed. The frequently requested criteria may change in response to particular situations or environments or may simply change over time. By updating the criteria, the system can create and maintain network links that correspond with the end devices' current transmission goals.

Frequently requested criteria 310 can be used to generate pre-identified network links 320. A set of network links may correspond to one or more of the frequently requested criteria. The system can evaluate how each link meets the criteria and rank the links. Using these rankings, the system can form a path between remote servers that employ the highest-ranking links. The links forming the path would comprise the set of pre-identified network links. In some embodiments, multiple vehicles or entities in the vehicular knowledge network can determine frequently requested criteria. The system can link entities by comparing the determined criteria to ensure that the constraint of frequently requested criteria is met. In some embodiments, a set of network links may be generated for each of the frequently requested criteria. In other embodiments, a set of network links may take into account multiple criteria. Each set of network links can be updated according to network conditions. That is, as network conditions change, the rankings between links may be different based on the involved criteria. By updating with network conditions, the set of pre-identified network links is current and can meet the criteria regardless of network conditions. In some embodiments, each set of pre-identified links could be transmitted as knowledge and can be made available to end devices.

At block 330, the system can apply pre-identified network links 320. At block 332, a vehicle can create knowledge to be transmitted. At block 334, a set of network links can be deployed to facilitate the knowledge transmission. In embodiments where multiple sets of network links are created, the system can select one set to use. The set may be selected based on the most frequently requested criterion. In other embodiments, the set may be selected randomly. In other embodiments, the set may be selected based on the criterion most recently requested by the vehicle. Once the set of network links is retrieved, it can be deployed at block 334 to facilitate transmission. The set of network links can connect remote servers together in vehicular knowledge sharing network 200. The remote servers can be configured based on the set of network links to transmit the knowledge to the next appropriate remote server in the path until the path is completed. Once the knowledge has completed the transmission path, in some embodiments, the set of network links can be released and returned to storage until new knowledge is created. In other embodiments, the set of networks links can be maintained in anticipating of new knowledge. As mentioned above, the set of network links can be updated based on network conditions or new criteria. If new criteria elicit a new set of network links, the old set of network links can be released and replaced with the new set.

At block 336, the system can evaluate the benefits of the deployed set of network links. The benefits can be measured based on the criteria and how the knowledge actually transmitted across the set of network links. The system can measure the benefits based on the relative criteria. For example, if the criterion is maximum diversity, the system can measure how many end devices were reached. If the criterion is minimum interruption, the system can measure the total or individual length of any interruptions experienced during the knowledge transmission. In some embodiments, these measurements can be compared to previous or default transmission paths. If the measurements indicate that the previous or default transmission path would have better met the criteria, the system can update the set of network links to meet the previous transmission path. Alternatively, the system can reevaluate the available links and form a new set of pre-identified network links for future use. As more knowledge is created and transmitted, the system can further refine the set of network links so that they can over time closer meet the criteria.

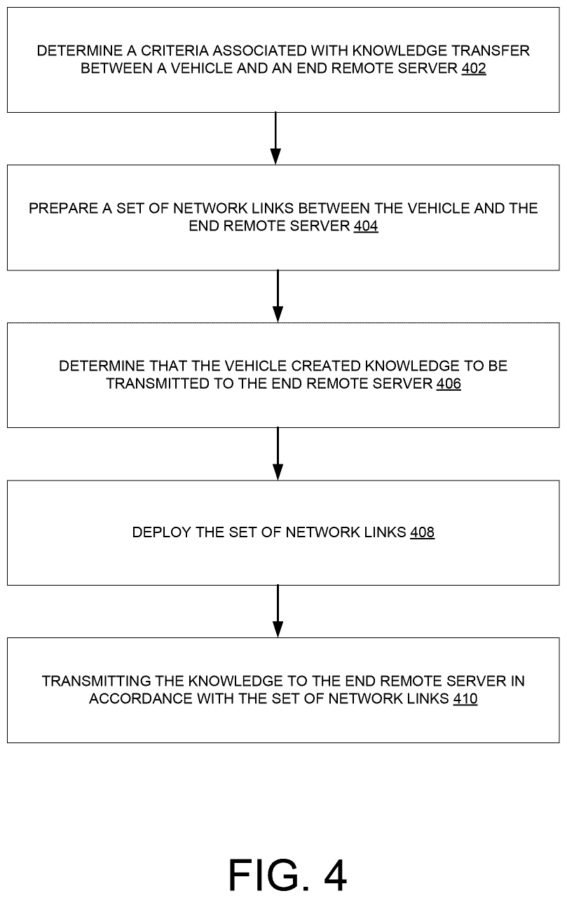

FIG. 4 illustrates an example method in accordance with the systems described above. At block 402, the system can determine a criteria associated with knowledge transfer between a vehicle and an end remote server. In some embodiments, the knowledge transfer can be between the vehicle and any end entity such as another vehicle, roadside unit, etc. As described above, the system can receive requested criteria from end devices such as vehicles or edge servers. These criteria can indicate particular goals associated with knowledge transmission. Criteria can include, but is not limited to, maximum data/information/knowledge diversity, maximum target users, minimum interruption, and/or maximum quality. In some embodiments, a remote server can perform a time series analysis on network 200 or other vehicular networks to derive the most frequently requested criteria. In other embodiments, the criteria may be predetermined. In systems where time series analysis is employed, the system can periodically update the most frequently requested criteria.

At block 404, the system can prepare a set of network links between the vehicle and the end remote server based on the criteria. As described above, a set of network links may correspond to one or more of the frequently requested criteria. The system can evaluate how each link meets the criteria and rank the links. Using these rankings, the system can form a path between remote servers that employ the highest-ranking links. The links forming the path would comprise the set of pre-identified network links. In some embodiments, a set of network links may be generated for each of the frequently requested criteria. In other embodiments, a set of network links may take into account multiple criteria. Each set of network links can be updated according to network conditions.

At block 406, the system can determine that the vehicle created knowledge to be transmitted to the end remote server. At block 408, the system can deploy the set of network links to facilitate the knowledge transmission. As described above, the set of network links can connect remote servers together in vehicular knowledge sharing network 200. The remote servers can be configured based on the set of network links to transmit the knowledge to the next appropriate remote server in the path until the path is completed. Once the knowledge has completed the transmission path, in some embodiments, the set of network links can be released and returned to storage until new knowledge is created. In other embodiments, the set of networks links can be maintained in anticipation of new knowledge. As mentioned above, the set of network links can be updated based on network conditions or new criteria. If new criteria elicit a new set of network links, the old set of network links can be released and replaced with the new set. At block 410, the knowledge can be transmitted to the end remote server in accordance with the set of network links.

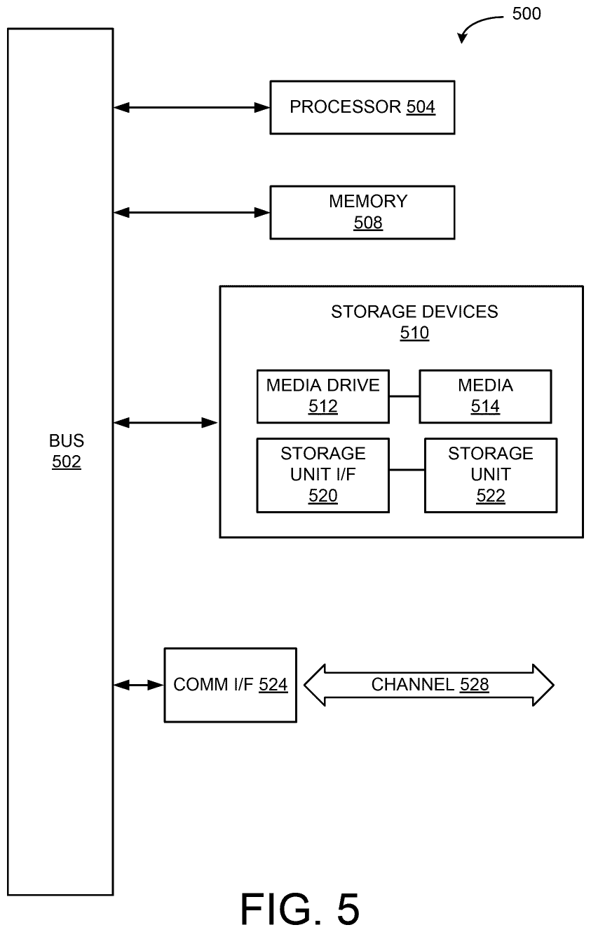

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment.

Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
determining a criterion associated with knowledge transfer between a vehicle and an end entity;
preparing a set of network links between the vehicle and the end entity based on the determined criterion;
determining whether the vehicle created knowledge to be transmitted to the end entity, wherein the knowledge comprises patterns of information generated by processing sensor data from the vehicle;
deploying the set of network links based on a determination that the vehicle created knowledge to be transmitted to the end entity; and
transmitting the knowledge to the end entity in accordance with the set of network links.

2. The method of claim 1, wherein the set of network links connect a plurality of remote servers between the vehicle and the end entity.

3. The method of claim 1, further comprising:
analyzing the transmission of the knowledge based on the criterion; and
updating the set of network links.

4. The method of claim 1, wherein the criterion is associated with knowledge transfer between a plurality of vehicles and the end entity.

5. The method of claim 1, wherein the criterion comprises at least one of maximum data diversity or maximum target users.

6. The method of claim 1, wherein determining the criterion comprises performing a time series analysis on the vehicle and the end entity to determine the criterion.

7. The method of claim 1, further comprising storing the set of network links to be deployed in future knowledge transmission.

8. The method of claim 7, wherein the set of network links can be deployed in future knowledge transmission associated with the criterion.

9. A system, comprising:
a processor; and
a memory coupled to the processor to store instructions, which when executed by the processor, cause the processor to:
determine a plurality of criteria associated with knowledge transfer between a vehicle, an end entity, and a plurality of remote servers linking the vehicle to the end entity;
prepare a set of network links between the vehicle and the end entity traversing the plurality of remote servers based on the plurality of criteria;
determine whether the vehicle created knowledge to be transmitted to the end entity, wherein the knowledge comprises patterns of information generated by processing sensor data from the vehicle;
deploy the set of network links based on a determination that the vehicle created knowledge to be transmitted to the end entity; and
transmit the knowledge between the plurality of remote servers to the end entity in accordance with the set of network links.

10. The system of claim 9, wherein the instructions further cause the processor to:
analyze the transmission of the knowledge based on the criteria; and
update the set of network links.

11. The system of claim 9, wherein the criteria is associated with knowledge transfer between a plurality of vehicles and the end entity.

12. The system of claim 9, wherein the criteria comprise at least one of maximum data diversity or maximum target users.

13. The system of claim 9, wherein determining the criteria comprises performing a time series analysis on the vehicle, the plurality of remote servers, and the end entity to determine the criteria.

14. The system of claim 9, wherein the processor is further configured to store the set of network links to be deployed in future knowledge transmission.

15. The system of claim 14, wherein the set of network links can be deployed in future knowledge transmission associated with the criteria.

16. A non-transitory machine-readable medium having instructions stored therein, which when executed by a processor, cause the processor to:
determine a criterion associated with knowledge transfer between a vehicle and an end entity;
prepare a set of network links between the vehicle and the end entity based on the determined criterion;
determine whether the vehicle created knowledge to be transmitted to the end entity, wherein the knowledge comprises patterns of information generated by processing sensor data from the vehicle;
deploy the set of network links based on a determination that the vehicle created knowledge to be transmitted to the end entity;
transmit the knowledge to the entity in accordance with the set of network links; and
store the set of network links to be deployed in future knowledge transmission.

17. The non-transitory machine-readable medium of claim 16, wherein the instructions further cause the processor to:
analyze the transmission of the knowledge based on the criterion; and
update the set of network links.

18. The non-transitory machine-readable medium of claim 16, wherein the criterion comprises at least one of maximum data diversity or maximum target users.

19. The non-transitory machine-readable medium of claim 16, wherein determining the criterion comprises performing a time series analysis on the vehicle and the end entity to determine the criterion.

20. The non-transitory machine-readable medium of claim 16, wherein the set of network links can be deployed in future knowledge transmission associated with the criterion.
